(19) United States
(12) Patent Application Publication
(10) Pub. No.: US 2025/0228724 A1
(43) Pub. Date: Jul. 17, 2025

(54) Lift Assist Device

(71) Applicants: Christopher Wesley, Denham Springs, LA (US); Cody Thurmon, Central, LA (US)

(72) Inventors: Christopher Wesley, Denham Springs, LA (US); Cody Thurmon, Central, LA (US)

(21) Appl. No.: 19/022,931

(22) Filed: Jan. 15, 2025

Related U.S. Application Data
(60) Provisional application No. 63/621,062, filed on Jan. 15, 2024.

(51) Int. Cl. A61G 7/10

(52) U.S. Cl. CPC A61G 7/1023

(57) ABSTRACT

A lift assist device having an elongated strap and two handles. The strap is composed of a webbing material coated in a thermoplastic polyurethane to prevent the contamination of the device. To use the list assist device, the elongated strap is placed beneath the back or buttocks of a downed individual, while two other individuals pull of the handles, thus lifting the downed individual from the ground.

### FIELD OF THE INVENTION

The present invention relates generally to a device for assisting in lifting an individual. More specifically, the present invention is a device with two handles, composed of a non-permeable material to permit users to clean the device.

### BACKGROUND OF THE INVENTION

Lift assist devices including conventional designs employing straps with two handles have encountered a substantial challenge pertaining to maintenance and cleanliness. A prevalent drawback within the prior art lies in the permeability of the webbing material employed in these devices. This permeability results in an ineffective means of cleaning the strap, as fluids and contaminants easily infiltrate the fabric, rendering traditional lift assist devices susceptible to hygiene concerns and diminished durability.

Existing lift assist devices employing similar strap configurations have, to a significant extent, failed in addressing the critical issue of fluid and contaminant absorption. The permeable nature of the webbing material commonly used in prior art hampers the ability to thoroughly clean the device, leading to hygiene-related complications and a compromised user experience. The inability to prevent fluids from permeating the strap poses a considerable limitation, as it not only compromises the device's cleanliness but also raises concerns related to the longevity and integrity of the lift assist apparatus.

This significant pitfall within the prior art has prompted a demand for innovative solutions that effectively mitigate the challenges associated with cleaning and maintaining lift assist devices. Recognizing the limitations of existing designs, the present invention introduces a novel approach by incorporating a strap composed of thermoplastic polyurethane (TPU). The application of TPU coating to the lift assist device strap serves as a pivotal feature that sets it apart from its predecessors.

The key differentiator lies in the impermeable nature of thermoplastic polyurethane, which forms a robust barrier against the infiltration of fluids and contaminants. This impermeability addresses the critical concern observed in the prior art, providing users with an enhanced means of cleaning the lift assist device. By preventing the absorption of fluids into the strap material, the present invention significantly improves the overall cleanliness and hygiene of the device, addressing a long-standing challenge in the domain of lift assist devices.

The utilization of TPU coating not only serves as a functional enhancement but also contributes to the durability and longevity of the lift assist device. The impermeable nature of TPU ensures that the strap remains resilient against the detrimental effects of prolonged exposure to fluids and contaminants, thereby enhancing the overall reliability and performance of the invention.

In conclusion, the prior art's inherent flaw concerning the permeability of strap materials in lift assist devices has been a persistent challenge. The present invention strategically employs thermoplastic polyurethane coating to overcome this limitation, offering users an innovative solution that prioritizes cleanliness, hygiene, and extended device lifespan. This advancement represents a significant leap forward in the evolution of lift assist devices, addressing a crucial aspect that has long impeded the optimal functionality of such apparatuses in various applications.

### BRIEF DESCRIPTION OF THE DRAWINGS

FIG. 1 is a front perspective view of the present invention.

FIG. 2 is a rear perspective view of the present invention.

FIG. 3 is a diagram of the material of the present invention

FIG. 4 is a diagram of the present invention in use by two users.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification, and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate.

The present disclosure includes many aspects and features. Moreover, while many aspects and features relate to, and are described in the context of a lift assist device 1, embodiments of the present disclosure are not limited to use only in this context.

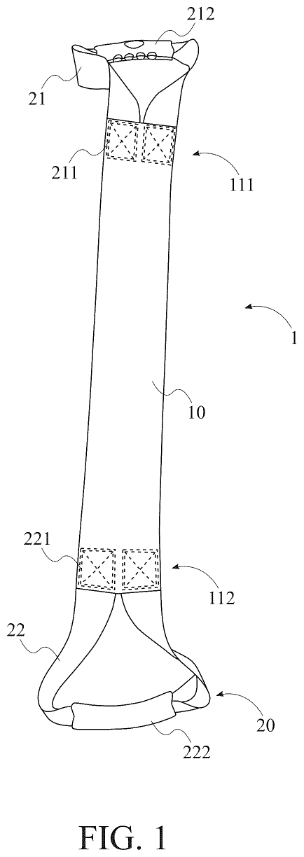

The present invention, as shown in FIG. 1, is a lift assist device 1 comprising a main strap 10 and a plurality of handles 20. The main strap 10 of the present invention is composed of a thin, elongated body comprising a first end 111 and a second end 112 wherein said ends are opposite distal ends of the main strap 10. In the context of the present invention, the term “thin” is in regard to a thickness of the material wherein said thickness is substantially smaller than a length of the main strap 10.

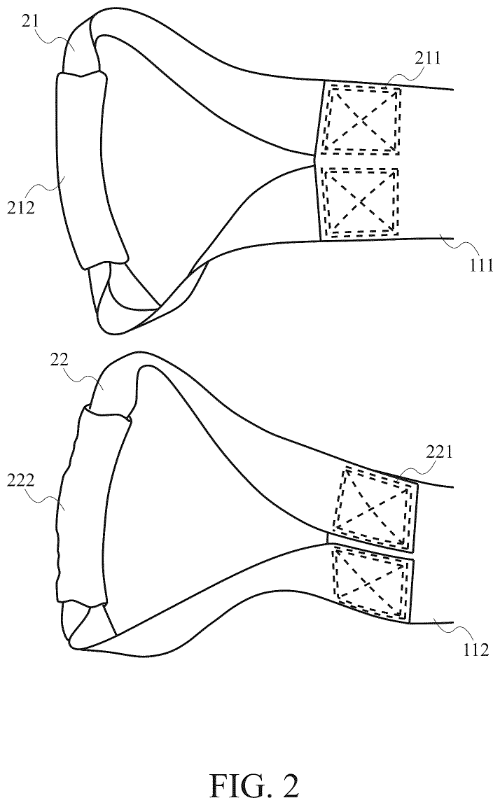

Furthermore, within the preferred embodiment of the present invention, the plurality of handles 20, as shown in FIG. 1 and FIG. 2, are each composed of a strap member 21 and a grip 212. Each strap member 21,22 comprises a first end and a second end wherein said ends are opposite distal ends of the strap member 21,22. In the preferred embodiment of the present invention, each of the distal ends of each strap member 21,22, are secured to a respective distal end of the main strap 10. In the context of the present invention, the first strap member 21 is secured to the first distal end 111 of the main strap 10, such that each of the distal ends of the first strap member 21 are secured to the first distal end 111 of the main strap 10, thus forming a looped configuration composed by the first strap member 21. Likewise, in the context of the present invention, the second strap member 22 is secured to the second distal end 112 of the main strap 10, such that each of the distal ends of the second strap member 22 are secured to the second distal end 112 of the main strap 10, thus forming a looped configuration composed by the second strap member 22. Additionally, in the context of the present invention, the first strap member comprises a grip 212 and the second strap member comprises a grip 222, wherein each grip 212,222 is a tubular body located at a proximal position on the respective strap member 21,22, in between the first end and the second end of the respective strap 21,22. Each of the plurality of handles 20 is attached to an opposite distal end of the main strap 10. In the preferred embodiment of the present invention, each strap member 21,22 is secured to an opposite distal end of the main strap 10, such that each of the plurality of handles 20 is configured in a U-shaped configuration, wherein each distal end of the strap member 21,22 is sewn onto the same distal end of the main strap 10, as shown in FIG. 2.

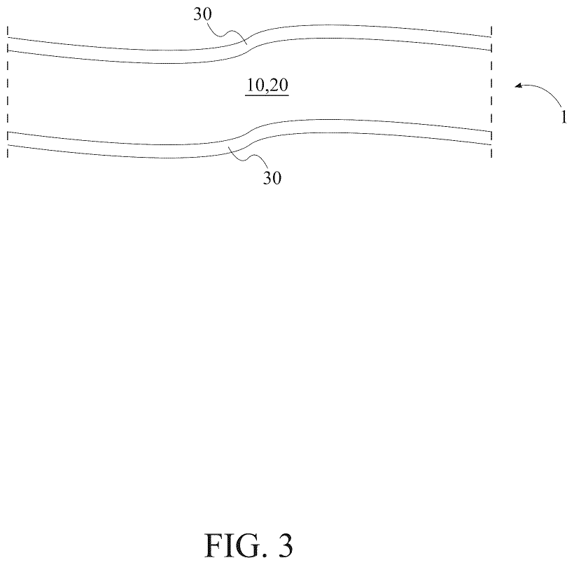

In the preferred embodiment of the present invention, the plurality of handles 20 are secured onto the main strap 10 through a plurality of reinforced connection members 211,221. In some embodiments of the present invention, the plurality of reinforced connection members 211,221 are composed of reinforced stitching, as shown in FIG. 3. In the context of the present invention, the first strap member 21 is coupled to the first distal end 111 of the main strap 10 through a first reinforced connection member 211, and the second strap member 22 is secured to the second distal end 112 of the main strap 10 through a second reinforced connection member 221. In the preferred embodiment of the present invention, each of the plurality of reinforced connection members 211,221 are stitched as such a connection member provides a simple manufacturing method when securing material such as webbing. Furthermore, in the preferred embodiment of the present invention, the plurality of grips 212,222 are composed of a rubber material. Although a rubber material is disclosed herein as composing the plurality of grips 212,222, the material is not limited to such.

In the preferred embodiment of the present invention, the main strap 10 is four inches in width and each of the plurality of handles 20 are two inches in width. Further, in the preferred embodiment of the present invention, the main strap 10 and the plurality of handles 20 are composed of a webbing material comprising an impermeable coating 30 wherein said webbing material is coated in a thermoplastic polyurethane, as shown in FIG. 3. The thermoplastic polyurethane is essential to the present invention as this thermoplastic polyurethane provides an impermeable coating over the straps, thereby enabling a user to wipe the present invention down after using the lift assist device 1. Without the impermeable coating 30, the present invention is incapable of being properly cleaned and sanitized as dirt, bodily fluids, bacteria, and other contaminants may seep into the weave of the webbing.

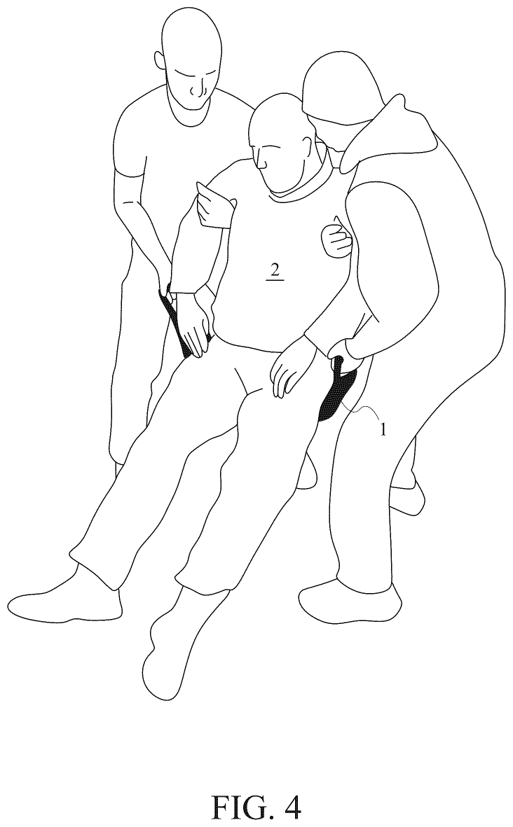

As shown in FIG. 4, to use the present invention, the main strap 10 is slid underneath the back or buttocks of a downed individual 2 and an upward force is applied to the handles. In the preferred embodiment of the present invention, each handle is held and pulled by a unique individual, thus allowing two people to assist in the lifting of a single, downed individual 2. The clean the device, a user may simply wipe the device clean as any potentially contaminated fluids or substances are prevented from permeating the webbing via the thermoplastic polyurethane coating 30.

Although the invention has been explained in relation to its preferred embodiment, it is to be understood that many other possible modifications and variations can be made without departing from the spirit and scope of the invention.

What is claimed as:

1. A lift assist device comprising:
a main strap;
a plurality of handles; and
a coating;
wherein:
the main strap is an elongated member;
the plurality of handles are secured to the main strap; and
the coating being an impermeable sealant covering the main strap and the plurality of handles.

2. The lift assist device as claimed in claim 1, wherein the main strap comprises a plurality of distal ends wherein said distal ends are opposing ends of the main strap; and
each of the handles of the plurality of handles are secured to one of the distal ends of the plurality of distal ends of the main strap.

3. The lift assist device as claimed in claim 2 wherein:
the plurality of handles comprises a first handle and a second handle;
the plurality of distal ends of the main body comprises a first distal end and a second end;
the first handle is secured to the first distal end of the main strap; and
the second handle is secured to the second distal end of the main strap.

4. The lift assist device as claimed in claim 3, wherein:
each of the plurality of handles is composed of an elongated member comprising two distal ends such that each of the members is configured into a U-shape configuration such that each of the distal ends of the elongated members composing each of the plurality of handles is secured to the respective distal end of the main strap.

5. The lift assist device as claimed in claim 4 wherein the first handle comprises an ergonomic grip.

6. The lift assist device as claimed in claim 4 wherein the second handle comprises an ergonomic grip.

7. The lift assist device as claimed in claim 4 further comprising a plurality of reinforced connection members wherein said connection members secure the first handle to the first distal end of the main strap and further secure the second handle to the second distal end of the main strap.

8. The lift assist device as claimed in claim 7 wherein the coating is a polyurethane coating.

9. The lift assist device as claimed in claim 7 wherein each of the reinforced connection members are composed of stitching.

10. A lift assist device comprising:
a main strap;
a plurality of handles; and
a coating;
wherein:
the plurality of handles comprises a first handle and a second handle;
the first handle comprises an ergonomic grip such that said ergonomic grip is positioned at a proximal portion of the first handle;
the second handle comprises an ergonomic grip such that said ergonomic grip is positioned at a proximal portion of the second handle;
the main strap being an elongated member;
the first handle and the second handle secured to the main strap; and
the coating being an impermeable sealant covering the entirety of the main strap and the plurality of handles.

11. The lift assist device as claimed in claim 10 wherein the main strap comprises a plurality of distal ends;
the plurality of distal ends comprises a first end and a second end;
the first end and the second end are opposing distal ends of the main strap;
the first handle being coupled to the first distal end of the main strap; and
the second handle being coupled to the second distal end of the main strap.

12. The lift assist device as claimed in claim 11 wherein:
the first handle is a U-shaped member; and
the second handle is a U-shaped member.

13. The lift assist device as claimed in claim 11 further comprising a plurality of reinforced connection members wherein said connection members secure the first handle to the first distal end of the main strap and further secure the second handle to the second distal end of the main strap.

14. The lift assist device as claimed in claim 11 wherein the coating is a polyurethane coating.

15. The lift assist device as claimed in claim 13 wherein each of the reinforced connection members are composed of stitching.

16. A lift assist device comprising:
a main strap;
a plurality of handles; and
a coating;
wherein:
the main strap is an elongated member comprising a plurality of distal ends;
the plurality of handles are U-shaped members;
the plurality of handles comprise a first handle and a second handle;
each of the first handle and the second handle are secured to different distal ends of the plurality of distal ends of the main strap; and
the coating being an impermeable sealant covering the main strap and the plurality of handles.

17. The list assist device, as claimed in claim 16, wherein:
the first handle comprises an ergonomic grip positioned on a proximal portion of the first handle; and
the second handle comprises an ergonomic grip positioned on a proximal portion of the second handle.

18. The lift assist device as claimed in claim 17 wherein:
the plurality of distal ends comprises a first end and a second end;
the first end and the second end are opposing distal ends of the main strap;
the first handle being coupled to the first distal end of the main strap; and
the second handle being coupled to the second distal end of the main strap.

19. The lift assist device as claimed in claim 18 further comprising a plurality of reinforced connection members wherein said connection members secure the first handle to the first distal end of the main strap and further secure the second handle to the second distal end of the main strap.

20. The lift assist device as claimed in claim 19 wherein the coating is a polyurethane coating.
